(19) United States
(12) Patent Application Publication
(10) Pub. No.: US 2010/0328454 A1
(43) Pub. Date: Dec. 30, 2010

(54) SHAPE MEASURING DEVICE AND METHOD, AND PROGRAM

(75) Inventor: Tomoaki YAMADA, Tokyo (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 12/876,928

(22) Filed: Sep. 7, 2010

Related U.S. Application Data
(63) Continuation of application No. PCT/JP2009/054272, filed on Mar. 6, 2009.

(30) Foreign Application Priority Data
Mar. 7, 2008 (JP) P2008-057704

(51) Int. Cl. H04N 7/18

(52) U.S. Cl. 348/135; 348/E07.085

(57) ABSTRACT

The invention relates to a shape measuring device and method, and a program therefor, that allow measuring the shape of a test object, more simply and reliably, using a single-chip color sensor.

An optical low-pass filter (24) expands a slit beam reflected on a test object (12), in a direction perpendicular to a baseline direction. A CCD sensor (25) has R, G and B pixels arranged in a Bayer array, and the CCD sensor (25) outputs image signals that are obtained by the pixels receiving the slit beam. On the basis of image signals of the G pixels, an image processing unit (26) detects the timing at which the slit beam passes over a site of the test object (12) that is pre-set for the G pixels and, on the basis of image signals of the R pixels and the B pixels, controls a projection unit (22) to adjust the intensity of the slit beam. A dot group computing unit (27) computes the position of the test object (12) on the basis of the timing detected for the G pixels. The invention can be used in a three-dimensional shape measuring device.

### TECHNICAL FIELD

The present invention relates to a shape measuring device and method, and a program therefor. More particularly, the present invention relates to a shape measuring device and method, and a program therefor, that allow measuring the three-dimensional shape of a test object using a single-chip color image capture element.

### BACKGROUND ART

Known shape measuring devices that measure the shape of industrial components or the like, as test objects, include devices wherein the three-dimensional shape of a test object is measured by optical sectioning (for instance, Patent document 1).

In such shape measuring devices, a slit pattern is projected from a light source onto a test object, and there is detected an image of the slit beam spread on the test object, from a direction that is different from the direction in which the slit pattern is projected, to obtain thereby, by triangulation, the three-dimensional shape of the test object.

In the shape measuring device, more specifically, the position of the test object and the position of an image capture element that captures the slit pattern irradiated onto the test object are kept as fixed positions. Also, the site of the test object at which an image of the irradiated slit beam is captured is pre-set for each pixel. In the shape measuring device, the light source is caused to turn, to change the irradiation direction of the slit beam and scan thereby the slit beam over the test object, whereupon there is captured the test object onto which the slit beam is irradiated. On the basis of the image obtained by capture, the shape measuring device detects the timing at which the slit beam passes over each site on the test object, to measure thereby the shape of the test object and to reproduce the shape.

Patent document 1: JP 3873401 B

### DISCLOSURE OF THE INVENTION

Single-chip black and white sensors, comprising a CCD (Charge Coupled Device) sensor or a CMOS (Complementary Metal Oxide Semiconductor) sensor are used, as the image capture element, in the shape measuring device, since color information is often not necessary for measuring the test object, and because it is preferable, in high-precision measurements, that information on the shape of the test object should be obtained continuously over all the pixels of the image capture element. Another reason for the use of single-chip black and white sensors lies in the continued supply of single-chip black and white sensors, on account of the demand thereof for three-chip color sensors.

However, the quality of single-chip color sensors has improved in recent years in the wake of ever smaller pixels in image capture elements, and thus the supply of single-chip black and white sensors looks set to decrease. Accordingly, there has been a demand for improvements in the measurement quality of test object shapes in shape measuring devices that employ single-chip color sensors.

In single-chip color sensors, for instance, mutually adjacent pixels have dissimilar light-reception sensitivities to light of a predetermined wavelength. Therefore, it has been difficult to work out the intensity of light that strikes a predetermined pixel by interpolation, on the basis of the intensity of light that strikes surrounding pixels.

For instance, a wavelength component of light that can be received by a predetermined pixel may sometimes be absorbed by the test object, so that light intensity from the test object fails to be detected for that pixel. In such cases it is difficult to know the intensity of light reflected by the test object for that predetermined pixel. As a result, information that ought to be obtained for that pixel goes missing, and the shape of the test object may fail to be measured.

In the light of the above, it is an object of the present invention to allow measuring the shape of a test object, more simply and reliably, using a single-chip color sensor.

The shape measuring device of the present invention is a shape measuring device: having light beam projection means for projecting a measurement light beam of a predetermined wavelength having a long pattern in one direction, onto a test object; image capture means for receiving a reflected light beam of the measurement light beam and outputting an image signal; and shape measuring means for measuring the shape of the test object on the basis of the image signal, wherein the image capture means is configured in such a manner that first pixels that receive light of a specific wavelength band including the predetermined wavelength, and second pixels having a lower light-reception sensitivity than that of the first pixels with respect to light of the predetermined wavelength, are alternately arrayed, and both the first pixels and the second pixels receive the reflected light beam, from a same site of the test object, whereby mutually different image signals are outputted; and the shape measuring means comprises a signal processing unit for processing image signals from each of the first pixels and the second pixels, and for measuring the shape of sites on the test object.

The shape measuring method and the program therefor of the present invention include: a step of projecting a measurement light beam of a predetermined wavelength having a long pattern in one direction, onto a test object; a step of acquiring an image signal relating to an image of a test object onto which the measurement light beam is projected, by way of an image capture means comprising first pixels that receive light of a specific wavelength band including the predetermined wavelength, and second pixels having a lower light-reception sensitivity than that of the first pixels with respect to light of the predetermined wavelength, the first pixels and the second pixels being alternately arrayed in the predetermined direction, both the first pixels and the second pixels receiving the reflected light beam from a same position at the test object; an adjustment step of adjusting the intensity of the measurement light beam that is projected by the light beam projection means, on the basis of a signal from the second pixels, from among image signals obtained through reception of the reflected light beam; and a shape measurement step of measuring the shape of the test object on the basis of an image signal relating to the image of the test object onto which the adjusted measurement light beam is projected.

The present invention allows measuring the shape of a test object, more simply and reliably, using a single-chip color sensor.

### BRIEF DESCRIPTION OF THE DRAWINGS

FIG. 1 is a diagram illustrating an example of the configuration of an embodiment of a shape measuring device of the present invention;

FIG. 2 is a diagram illustrating an example of a pixel array in a CCD sensor;

FIG. 3 is a diagram illustrating light-reception sensitivity of R, G and B pixels towards various wavelengths; and

FIG. 4 is a flowchart for explaining a shape measuring process.

### EXPLANATION OF THE REFERENCE NUMERALS

11 shape measuring device, 12 test object, 21 stage, 22 projection unit, 23 image capture lens, 24 optical low-pass filter, 25 CCD sensor, 26 image processing unit, 27 dot group computing unit, 28 overlay unit

### BEST MODE FOR CARRYING OUT THE INVENTION

Embodiments of the present invention are explained below with reference to accompanying drawings.

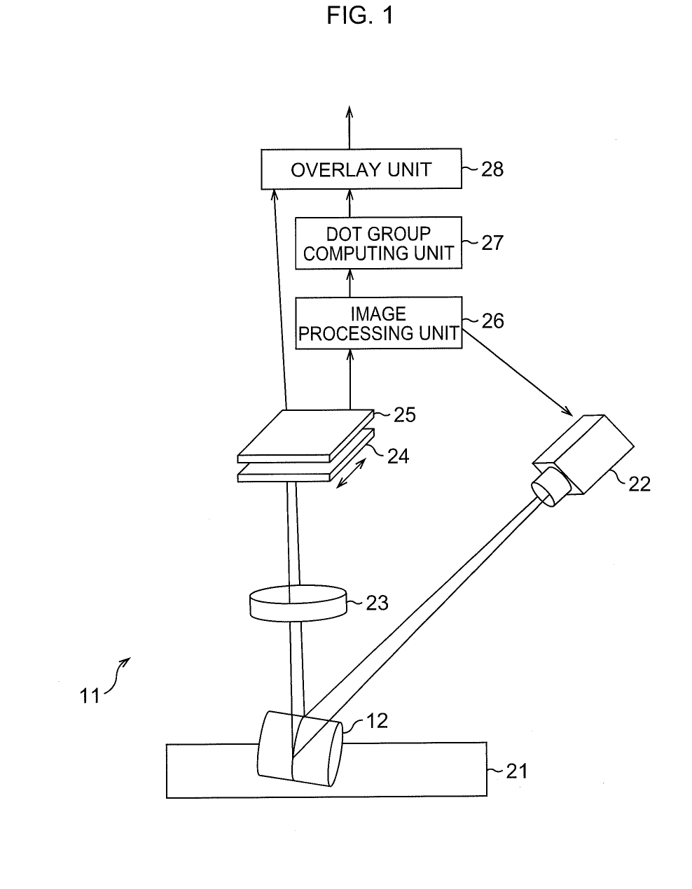

FIG. 1 is a diagram illustrating an example of the configuration of an embodiment of a shape measuring device of the present invention.

The shape measuring device 11 is a device that measures the three-dimensional shape of a test object 12 by optical sectioning. A test object 12 to be measured is placed on a stage 21 of the shape measuring device 11. The stage 21 remains fixed during the measurement of the test object 12.

A projection unit 22 projects a slit beam, which is a slit-shaped measurement light beam, onto the test object 12. The projection unit 22 scans the slit shape over the test object 12 by turning about an axis that is a straight line parallel to the longitudinal direction of the slit shape, i.e. the depth direction in the figure.

The slit shape projected on the test object 12 is reflected (diffused) at the surface of the test object 12, is deformed in accordance with the shape of the surface of the test object 12, and strikes an image capture lens 23. The incident image of the slit shape from the test object 12 that is incident on the image capture lens 23 is captured by a CCD sensor 25, via an optical low-pass filter 24. That is, the projection image of the slit shape on the test object 12 is captured by the CCD sensor 25 in a direction that is different from the direction in which the slit shape is projected onto the test object 12.

The optical low-pass filter 24, which comprises, for instance, a birefringent crystal or the like, is an optical low-pass filter that shears and expands the slit image in a direction perpendicular to the baseline that joins the principal point of the image capture lens 23 and the projection unit 22, i.e. the longitudinal direction of the slit shape image that is formed on the CCD sensor 25. The optical low-pass filter 24 is disposed between the test object 12 and the CCD sensor 25.

The CCD sensor 25 is a single-chip color sensor. The light-receiving surface of the CCD sensor 25 is provided with R (red) pixels, G (green) pixels and B (blue) pixels, which receive R, G and B light, disposed in a Bayer array. In the CCD sensor 25 there are pre-set the sites, from among the sites of the test object 12, at which the reflected slit beam is captured by each respective G pixel comprised in the CCD sensor 25.

An image processing unit 26 obtains the timing at which the center of the image of the slit shape passes over the sites of the test object 12 corresponding to respective G pixels, on the basis of an image signal, for each pixel, from the CCD sensor 25. Specifically, the light intensity distribution of the slit shape in the transverse direction is a Gaussian distribution, and hence the image processing unit 26 determines the timing at which the change in the received light intensity is maximal, for each pixel. The image processing unit 26 supplies, to a dot group computing unit 27, information designating the obtained pass-over time for each G pixel. The image processing unit 26 controls the projection unit 22 on the basis of image signals of the R pixels and B pixels, and adjusts, as the case may require, the intensity of the slit beam (intensity) that is projected by the projection unit 22.

The dot group computing unit 27 obtains a projection angle θa of the slit beam at the timing at which the slit beam passes over the sites of the test object 12 corresponding to the G pixels, on the basis of the information designating the timing for each G pixel that is supplied by the image processing unit 26. The projection angle θa denotes herein the angle formed by the baseline, which is the straight line that joins the principal point of the image capture lens 23 and the projection unit 22, and the main light ray of the slit beam (optical path of the slit beam) that is emitted by the projection unit 22.

The dot group computing unit 27 computes, for each G pixel, the position of the site of the test object 12 that is pre-set for that G pixel, on the basis of, for instance, a light reception angle Op of the slit beam, the length of the baseline (baseline length L) and the projection angle θa. On the basis of the computation results, the dot group computing unit 27 generates position information that designates the position of each site of the test object 12. The light reception angle θp is the angle formed by the baseline and the main light ray of the slit beam that strikes the CCD sensor 25 (optical path of the slit beam).

The dot group computing unit 27 generates stereoscopic image data of the test object 12 using the generated position information, and supplies the data to an overlay unit 28.

On the basis of the color image of the test object 12 as supplied by the CCD sensor 25, the overlay unit 28 overlays a color texture (design) onto the stereoscopic image supplied by the dot group computing unit 27, in such a manner that a given design is imparted to the surface of the test object 12. A color stereoscopic image having information on the R, G and B colors for each pixel is formed thereby. The overlay unit 28 outputs, as the measurement results, the generated color stereoscopic shape image of the test object 12.

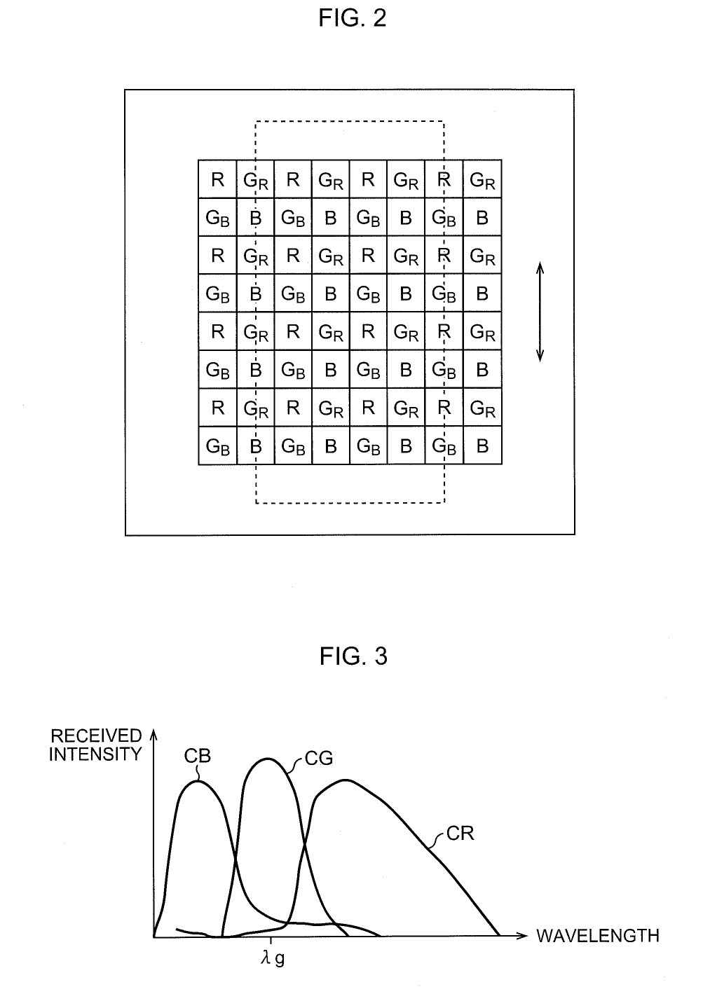

The R, G and B pixels are disposed in the form of a Bayer array, for instance as illustrated in FIG. 2, on the light-receiving surface of the CCD sensor 25. In FIG. 2, one square denotes one pixel. The letter “R” in the squares denotes R pixels that receive light having an R wavelength band, and the letter “B” denotes B pixels that receive light having a B wavelength band. Further, the character strings “G_{R}” and “G_{B}” in the squares denote G pixels that receive light having a G wavelength band and that are disposed between R pixels, and between B pixels, respectively, in the baseline direction. The baseline direction is the same direction as the transverse direction of the slit image at the time where the slit image projected onto the test object 12 forms an image on the light-receiving surface of the CCD sensor 25.

The broken-line rectangle in the figure indicates the slit image formed on the light-receiving surface of the CCD sensor 25. The arrow in the longitudinal direction of the slit image, i.e. in the vertical direction of the figure, denotes the horizontal shift direction of light beams by the optical low-pass filter 24.

In FIG. 2, the G pixels (G_{R} pixels and G_{B} pixels) are disposed in a checkerboard array, and the R pixels and B pixels are alternately disposed, every other row, in the remaining sites. That is, columns of R pixels and G_{B} pixels alternately disposed in the vertical direction of the figure, and columns of B pixels and G_{R} pixels alternately disposed in the vertical direction of the figure, are in turn disposed alternately in the horizontal direction of the figure.

An image signal obtained for G pixels is used to measure the shape of the test object 12. There are cases wherein, for some reason, a slit beam from sites corresponding to predetermined G_{R} pixels cannot be detected, for instance because the site of the test object 12 corresponding to the G_{R} pixel absorbs the component of the G wavelength band of the slit beam.

In the shape measuring device 11, however, the optical low-pass filter 24, having the vertical direction (direction perpendicular to the baseline direction) as the filter direction, is disposed between the image capture lens 23 and the light-receiving surface of the CCD sensor 25. As a result, the slit beam expands in the vertical direction of the figure, and part of the light that reaches the G_{R} pixels strikes two adjacent B pixels in the up-and-down direction. Upon projection of the slit image at the positions of the test object 12 that correspond to the G_{R} pixels, therefore, part of the light ray condensed onto the G_{R} pixels strikes two B pixels as well. Accordingly, the change in intensity of light condensed onto G_{R} pixels can be estimated on the basis of the above B pixels, even in case that light from the slit image cannot be detected due to absorption of light having a G_{R} reception wavelength band at sites corresponding to the G_{R} pixels. The shape of the test object 12 can be thus measured while preventing the occurrence of missing information on the G_{R} pixels.

As in the case of the G_{R} pixels, a light ray condensed onto G_{B} pixels strikes two adjacent R pixels in the up-and-down direction in the figure. Therefore, the change in condensed light intensity can be estimated on the basis of information from two R pixels, even if that light fails to be detected at the G_{B} pixels. The width to which the slit beam is expanded by the optical low-pass filter 24 is approximately a width such that the resolution of the slit image in the longitudinal direction in the figure does not drop, for instance the width of one pixel that is the sum of two half-pixels, i.e. a top half-pixel and a bottom half-pixel, on the light-receiving surface of the CCD sensor 25.

The slit image is scanned in the baseline direction, i.e. the horizontal direction in the figure. The direction of the optical low-pass filter 24 is perpendicular to the baseline direction. As a result, the slit beam does not expand in the measurement direction of the shape of the test object 12, i.e. the baseline direction. A high-resolution image of the slit beam can be obtained through measurement in the measurement direction. The precision with which the test object 12 is measured can be enhanced as a result.

The shape of the test object 12 is thus computed, on the basis of image signals obtained from each G (G_{R}, G_{B}) pixel, in the shape measuring device 11. Therefore, the projection wavelength of the slit image projected by the projection unit 22 is preferably, a wavelength λg that yields a maximum light-reception sensitivity by the G pixels, for instance as illustrated in FIG. 3. In FIG. 3, the X-axis represents the wavelength of light, and the Y-axis represents the light-reception sensitivity of the pixels. The curves CR, CG and CB represent the light-reception sensitivity is R, G and B pixels towards the wavelength.

In FIG. 3, the R, G and B pixels have respective light-reception sensitivities for different wavelength bands. For instance, the wavelength at which the light-reception sensitivity of G pixels is maximal is λg. The light-reception sensitivities of R pixels and B pixels at the wavelength λg are lower than the light-reception sensitivity of G pixels, namely about 2% and 5%, respectively. The wavelength for which light-reception sensitivity of R pixels is maximal is longer than kg, whereas the wavelength for which light-reception sensitivity of B pixels is maximal is shorter than kg.

The intensity of the slit beam that strikes the CCD sensor 25 varies significantly depending on the shape of the test object 12 and the texture (design) of the test object 12. Therefore, it may happen that some of the G pixels become saturated, from among the pixels at the light-receiving surface of the CCD sensor 25.

The R pixels and B pixels have certain light-reception sensitivity towards light of wavelength λg, although lower than that of G pixels. Therefore, some R pixels and B pixels often remain non-saturated even when G pixels become saturated due to excessive intensity of the slit beam projected by the projection unit 22. The ratio of light-reception sensitivity of the R pixels and B pixels to light of wavelength λg, with respect to the light-reception sensitivity of the G pixels, is decided beforehand.

In case of G pixel saturation, therefore, the degree to which the intensity of the slit beam ought to be weakened so as to preclude saturation of G pixels can be grasped on the basis of the intensity of the slit beam as indicated by image signals from the R pixels and the B pixels that surround the relevant G pixels. Accordingly, the image processing unit 26 detects G pixel saturation, for instance, by determining whether the value of an image signal of G pixels is equal to or greater than a predetermined threshold value, and adjusts the intensity of the slit beam projected by the projection unit 22 to an appropriate intensity, on the basis of the image signals from the R pixels and the B pixels.

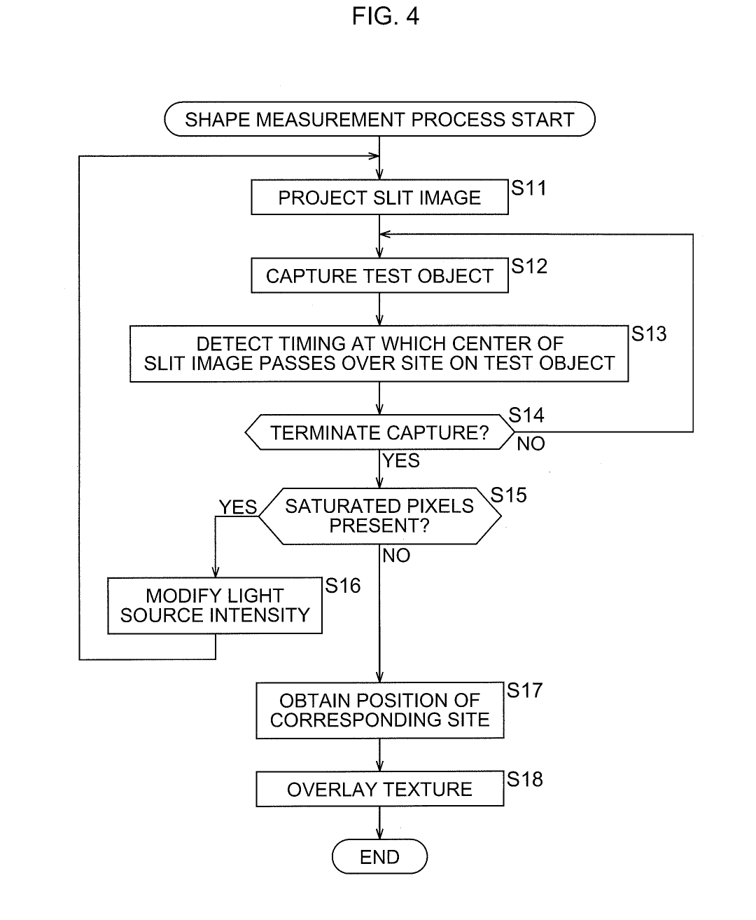

A shape measurement process wherein the shape measuring device 11 measures the shape of the test object 12 is explained next with reference to the flowchart of FIG. 4.

In step S11, the projection unit 22 projects a slit image onto the test object 12, while turning about an axis that is a straight line parallel to the shearing direction of the optical low-pass filter 24, to scan the slit beam over the test object 12. The slit beam projected onto the test object 12 is reflected on the surface of the test object 12, and strikes the CCD sensor 25 via the image capture lens 23 and the optical low-pass filter 24.

In step S12, the test object 12 is captured by the CCD sensor 25. Specifically, the pixels on the CCD sensor 25 are disposed mapped to pre-set sites of the test object 12. Therefore, the slit image projected onto the test object 12 is captured as the CCD sensor 25 detects changes in the light reception intensity of the pixels. Image signals obtained through capture, for respective pixels of the CCD sensor 25, are supplied to the image processing unit 26 and the overlay unit 28. An image of the test object 12 at each point in time is obtained as a result. More specifically, the image of the test object 12 that is supplied to the overlay unit 28 is captured using environment light alone, before the slit beam starts being projected. Thereafter, the image supplied to the image processing unit 26 is captured, after the slit beam starts being projected.

In step S13, the image processing unit 26 detects the timing at which the center of the slit image passes over the sites of the test object 12 that are pre-set for the G pixels, for each G pixel of the CCD sensor 25, on the basis of image signals from the CCD sensor 25. For instance, the image processing unit 26 performs interpolation on the basis of the supplied image signals, and obtains the intensity of the G pixels of interest at each point in time. The point in time at which intensity is greatest is taken as the point in time at which the center of the slit image passes over a corresponding site. Upon obtaining the timing at which the center of the slit image passes over corresponding sites, the image processing unit 26, supplies, to the dot group computing unit 27, information designating the obtained pass-over time for each G pixel.

In step S14, the shape measuring device 11 determines whether to terminate image capture of the test object 12. For instance, image capture is terminated when scanning of the test object 12 with the slit image is over.

When in step S14 it is determined not to terminate image capture, the process returns to step S12, and the above-described process is repeated. That is, the image of the test object 12 is captured over a given interval of time, and there is obtained the timing at which the slit image passes over each site, until termination of image capture.

By contrast, when in step S14 it is determined to terminate image capture, the image processing unit 26 determines, in step S15, whether or not there are saturated G pixels, on the basis of image signals of G pixels from the CCD sensor 25. For instance, it is determined that there are saturated G pixels if there are G pixels whose image signal value is greater than a threshold value thg pre-set for the G pixels.

The presence or absence of saturated G pixels may also be determined on the basis of image signals of R pixels and B pixels from the CCD sensor 25. In the latter case, it is determined that there are saturated G pixels if, for instance, there are R pixels whose image signal value is greater than a threshold value thr pre-set for the R pixels, or if there are B pixels whose image signal value is greater than a threshold value thb pre-set for the B pixels.

Saturation of G pixels may also be detected using just image signals of B pixels, whose light-reception sensitivity at the wavelength λg is higher than that of R pixels.

When in step S15 it is determined that there are saturated G pixels, the image processing unit 26 controls, in step S16, the projection unit 22, on the basis of the image signals of the R pixels and the B pixels, and modifies the intensity of the light source for projecting the slit image that is projected by the projection unit 22. Specifically, the image processing unit 26 modifies the light intensity of the slit image projected by the projection unit 22 to an intensity such that G pixels do not become saturated, on the basis of the image signal values from R pixels and B pixels that are near those G pixels deemed to be saturated, from among the image signals from the CCD 25. Once the light intensity of the slit image is adjusted, the process returns to step S11, and the above-described process is repeated.

By contrast, when in step S15 it is determined that there are no saturated G pixels, the dot group computing unit 27 obtains, in step S17, the positions of the sites of the test object 12 that correspond to respective G pixels, on the basis of information designating timings, from the image processing unit 26.

Specifically, the dot group computing unit 27 determines the projection angle θa of the slit beam at the timing at which the slit image passes over the sites of the test object 12 corresponding to the G pixels, on the basis of information designating the timing of each G pixel. The projection angle θa is obtained from the turning angle of the projection unit 22 at the timing (point in time) at which the slit image passes over a site. The dot group computing unit 27 computes by triangulation, for each G pixel, the position on the site of the test object 12, on the basis of the pre-set light reception angle θp, baseline length L, image distance b, and the positions of the G pixels on the CCD sensor 25, and on the basis of the obtained projection angle θa.

The image distance b is the axial distance between the image capture lens 23 and the slit image formed by the image capture lens 23. The image distance b is obtained beforehand. The test object 12, the image capture lens 23 and the CCD sensor 25 remain fixed during measurement of the shape of the test object 12. Therefore, the light reception angle θp is a known fixed value.

The dot group computing unit 27 obtains the position of the sites of the test object 12 corresponding to respective G pixels, and generates position information designating the position of each site. On the basis of the position information, the dot group computing unit 27 further generates a stereoscopic image that is supplied to the overlay unit 28.

In step S18, the overlay unit 28 overlays a color texture onto the stereoscopic image supplied by the dot group computing unit 27, on the basis of the image of the test object 12 as supplied by the CCD sensor 25. A color stereoscopic image having information on the R, G and B colors for each pixel is formed thereby. The overlay unit 28 outputs the color stereoscopic image obtained through texture overlaying, as the result of the shape measurement of the test object 12. This concludes the shape measurement process.

Thus, the shape measuring device 11 causes the slit beam to expand in a direction perpendicular to the baseline, captures an image of the slit beam, by way of the CCD sensor 25, and obtains the shape of the test object 12 on the basis of image signals obtained by image capture.

The slit beam can be received from a wider area from the test object 12, while preserving resolution in the measurement direction, by expanding thus the slit beam in a direction perpendicular to the baseline by way of the optical low-pass filter 24. Information loss can be prevented as a result, and the shape of the test object 12 can be measured yet more simply and reliably.

The intensity of the slit beam from each site can be obtained, without triggering G pixel saturation, by detecting saturation of the G pixels, and, as the case may require, by adjusting the light intensity of the slit image from the projection unit 22 on the basis of image signals of R pixels and B pixels. Therefore, the timing at which the slit beam passes over a corresponding site can be obtained yet more accurately, and the shape of the test object 12 can be measured thus yet more simply and reliably.

The shape of the test object 12 can be rendered more simply and more realistically through generation of a color stereoscopic image on the basis of a color image of the test object 12 that is captured using environment light. Specifically, to obtain a color image of the test object 12 in a conventional single-chip black and white sensor, it was necessary to capture images by inserting a filter of each color into the single-chip black and white sensor. Complex processing was also required. Using the CCD sensor 25, by contrast, allows obtaining a color image of the test object 12 in a simple manner that requires no special operation and in which pixels of respective colors are utilized effectively.

The light-reception sensitivity ratios between the R, G and B pixels at the wavelength λg are obtained beforehand. Upon detection of G pixel saturation, the intensity of the slit beam that is incident on saturated G pixels may be obtained, through interpolation, on the basis of image signals of non-saturated G pixels in the vicinity of saturated G pixels, and on the basis of image signals of R and B pixels in the vicinity of the G pixels.

That is, there is obtained the timing at which the slit beam passes over the sites of the test object 12 corresponding to the saturated G pixels, on the basis of image signals from other non-saturated G pixels, as well as R pixels and B pixels, that are in the vicinity of the saturated G pixels.

An example has been explained wherein the shape of the test object 12 is measured by determining the time centroid of slit beam intensity for each pixel. However, the shape of the test object 12 may also be measured by working out the pixels that receive the most intensity, from among the G pixels, for each point in time.

The above series of processes can be executed by hardware, or by software. In a case where the above series of processes is executed by software, a program for carrying out the series of processes and that is executed in the shape measuring device 11 can be recorded beforehand in a recording unit, not shown, of the shape measuring device 11, or can be installed in the recording unit of the shape measuring device 11 from an external device, such as a server, that is connected to the shape measuring device 11.

The program for carrying out the series of processes in the shape measuring device 11 may be acquired by the shape measuring device 11 from a removable medium such as a magnetic disk, an optical disk, a magneto-optical disk, a semiconductor memory or the like, and be recorded in the recording unit of the shape measuring device 11.

As the case may require, the program for executing the above-described series of processes may be installed in the shape measuring device 11 by way of a wired or wireless communication medium, via an interface such as a router or a modem, a local area network, the Internet or a digital satellite broadcast.

The program executed in a computer of, for instance, the shape measuring device 11, may be a program in which a process is carried out in a time series that follows the sequence explained in the present description, or may be a program in which the process is carried in parallel or in a required timing, for instance when called.

The embodiments of the present invention are not limited to the above-described ones, and various modifications can be made to the embodiments without departing from the scope of the present invention.

1. A shape measuring device comprising:
light beam projection means for projecting a measurement light beam of a predetermined wavelength having a long pattern in one direction, onto a test object;
image capture means for receiving a reflected light beam of the measurement light beam and outputting an image signal; and
shape measuring means for measuring the shape of the test object on the basis of the image signal,
wherein the image capture means is configured in such a manner that first pixels that receive light of a specific wavelength band including the predetermined wavelength, and second pixels having a lower light-reception sensitivity than that of the first pixels with respect to light of the predetermined wavelength, are alternately arrayed, and both the first pixels and the second pixels receive the reflected light beam, from a same site of the test object, whereby mutually different image signals are outputted; and
the shape measuring means comprises a signal processing unit for processing image signals from each of the first pixels and the second pixels, and for measuring the shape of sites on the test object.

2. The shape measuring device according to claim 1, further comprising:
adjustment means for adjusting the intensity of the measurement light beam that is projected by the light beam projection means, on the basis of a signal from the second pixels of the image capture means, from among the image signals.

3. The shape measuring device according to claim 1,
wherein the signal processing unit includes:
a saturation detection unit that detects saturation in the image signal corresponding to the first pixels; and
a computation unit that interpolates and computes values corresponding to light intensity received by the first pixels on the basis of an image signal from the second pixels, when saturation is detected by the saturation detection unit; and
wherein the shape of sites on the test object is measured on the basis of the values calculated by the computation unit.

4. The shape measuring device according to claim 1,
wherein the first pixels and the second pixels are arrayed in a direction that is perpendicular to a transverse direction of the pattern.

5. A shape measuring method, comprising:
a step of projecting a measurement light beam of a predetermined wavelength having a long pattern in one direction, onto a test object;
a step of acquiring an image signal relating to an image of a test object onto which the measurement light beam is projected, by way of an image capture means: comprising first pixels that receive light of a specific wavelength band including the predetermined wavelength; and second pixels having a lower light-reception sensitivity than that of the first pixels with respect to light of the predetermined wavelength, the first pixels and the second pixels being alternately arrayed in the predetermined direction, both the first pixels and the second pixels receiving the reflected light beam from a same position at the test object;
an adjustment step of adjusting the intensity of the measurement light beam that is projected, on the basis of a signal from the second pixels, from among image signals obtained through reception of the reflected light beam; and
a shape measurement step of measuring the shape of the test object on the basis of an image signal relating to the image of the test object onto which the adjusted measurement light beam is projected.

6. The shape measuring device according to claim 2,
wherein the first pixels and the second pixels are arrayed in a direction that is perpendicular to a transverse direction of the pattern.

7. The shape measuring device according to claim 3,
wherein the first pixels and the second pixels are arrayed in a direction that is perpendicular to a transverse direction of the pattern.

8. A program for causing a computer to execute a process, the process comprising:
a step of projecting a measurement light beam of a predetermined wavelength having a long pattern in one direction, onto a test object;
a step of acquiring an image signal relating to an image of a test object onto which the measurement light beam is projected, by way of an image capture means: comprising first pixels that receive light of a specific wavelength band including the predetermined wavelength, and second pixels having a lower light-reception sensitivity than that of the first pixels with respect to light of the predetermined wavelength, the first pixels and the second pixels being alternately arrayed in the predetermined direction, both the first pixels and the second pixels receiving the reflected light beam from a same position at the test object;
an adjustment step of adjusting the intensity of the measurement light beam that is projected, on the basis of a signal from the second pixels, from among image signals obtained through reception of the reflected light beam; and
a shape measurement step of measuring the shape of the test object on the basis of an image signal relating to the image of the test object onto which the adjusted measurement light beam is projected.
